(19) United States
(12) Patent Application Publication
(10) Pub. No.: US 2005/0086851 A1
(43) Pub. Date: Apr. 28, 2005

(54) Mesh liner for live bait containers

(76) Inventors: Michael F. Carden JR., San Antonio, TX (US); Bryant L. McCue, Houston, TX (US)

Correspondence Address: Donald W. Meeker, 924 East Ocean Front #E, Newport Beach, CA, 92661, US

(21) Appl. No.: 10/692,986

(22) Filed: Oct. 23, 2003

(51) Int. Cl. A01K 97/05; A01K 97/04

(52) U.S. Cl. 43/55; 43/56

(57) ABSTRACT

A mesh liner for a bait container that enables the bait to move along the liner with the live bait spread out along the sides of the container as well as on the bottom, thereby preventing the bait from smothering each other.

### BACKGROUND OF THE INVENTION

1. Field of the Invention

The present invention relates to live bait containers and particularly to a bait container with a mesh lining for supporting shrimp or other live bait spread out on the mesh around the sides of the container as well as on the bottom, thereby preventing the piling up of the live bait and preventing the death of the live bait which normally results from smothering and other effects of the life bait piled up on the bottom of the bait container.

2. Description of the Prior Art

Fishermen who use live bait such as shrimp, crayfish, crawfish or the like have long faced the problem of their live bait succumbing in the container in which it is kept before the bait can be used. Shrimp tend to group together and overcrowd one another, which reduces their survival rate. Customarily, fishermen purchase their live bait at a location remote from where the bait will be used. Due to overcrowding many of the shrimp will be dead when the fisherman arrives at the fishing location. Attempts have been made in prior art to extend the life of the bait by providing cooling or aeration devices, but this does not help with the overcrowding problem.

Prior art U.S. Pat. No. 4,697,380, issued Oct. 6, 1987 to Fenske, shows a bait container that is a refrigerated bait box having a main body portion, which includes a bottom wall, and front, back and first and second side walls, defining a principle interior chamber with an open top end. A main lid is hinged relative to the top edge of the back wall for pivotal movement between opened and closed positions. A recessed channel is provided along the top edge of the container portion for housing and supporting a webbed basket which occupies only a portion of the container space, with the interior of the space between the bottom of the basket and the floor portion of the container portion serving to house ice in the cubed form for allowing maintenance of the bait contained in the basket to remain cold yet the basket allowing any moisture from the bait to fall into the lower ice containing portion. There is further included a foot activated means for moving the top lid for “hands free” opening and closing. In the closed position the lid has a sealing member between itself and the main body portion and there is further included a closer lock for maintaining the lid closed.

Prior art U.S. Pat. No. 6,584,727, issued Jul. 1, 2003 to De Shazer, provides a live bait container for wade fishing and trolling, which comprises a hollow cylindrical shell with an integral bottom and a modified frustrum of a right cylinder forming the top. An access opening and cover assembly is disposed on the front face of the container. The container shall have a main and a top buoyancy chamber disposed to maintain the bait chamber submerged while keeping the access opening above water. The container's midsection, including the sloping back shall be plastic mesh. Other material used in the construction, except the access cover assembly, is generally of transparent plastic enabling the bait to be observed. The removable access cover assembly comprises a plurality of elastic strips with a retaining device on both ends that engage the container. Bait is recovered by reaching between the elastic strips. The container has a keel containing a handhold for carrying and a hole for a two line.

Prior art U.S. Patent Application #20030024932, published Feb. 6, 2003 by McQueen, puts forth an insert for an insulated container with a rectangular inner cavity, which is detachably positioned inside the cavity to form an inscribed wall with rounded inner surface. The insert is a rectangular sheet of flexible resilient material that unrolls inside the cavity due to a spring action of the material to cover the straight comers of the cavity. A reinforcing plate secured to the sheet helps retain the flexible plastic sheet in an upright position inside the cavity.

Prior art U.S. Pat. No. 6,357,169, issued Mar. 19, 2002 to Gouge, indicates a bait saver bucket with a multi-chambered container that has separations for segregating different sizes of live bait as well as providing slots for segregating fishing lines having bait and hook attached thereto, especially while relocating equipment from one location to another. The multi-chambered container comprises an outer container for holding an amount of fluid therein, a closure, a handle and an inner floating container. The inner floating container comprises removable basket-like compartments are oppositely opposed and spaced apart by a cover member having apertures substantially conforming to the top openings of the basket-like compartments and having a centrally disposed aperture having a hingedly attached cover for covering the aperture and when opened providing access to the interior of the remainder of the outside bucket enclosure not occupied by the compartments. The cover has slots for allowing leaders to pass through the cover without being crimped.

Prior art U.S. Pat. No. 3,601,095, issued Aug. 24, 1971 to Olsson, puts forth an apparatus to facilitate the rearing of the young of spawn-producing crustaceans, particularly crayfish, which comprises a box-like structure that includes an enclosure with a foraminous floor. One or more mothers are supported by the floor, through which the young drop after hatching into a collection compartment, which also has a foraminous floor. The floors for the mothers are made from wire mesh, while the floors for the collection area are made from a mesh size small enough to prevent escape of the young.

Prior art U.S. Pat. No. 4,513,525, issued Apr. 30, 1985 to Ward, puts forth a container assembly for receiving fishing minnows and the like. The assembly comprises an outer bucket, a removeable lid for sealing the bucket, a handle for carrying the bucket and a strainer basket for fitting inside the bucket. The strainer basket has a pair of handle portions which are detachable from one another and which can be moved to an out of the way position for gaining access into the basket.

Prior art U.S. Pat. No. 5,138,975, issued Aug. 18, 1992 to Walsh, claims a storage or transport system for small marine creatures that includes a container having a lid providing a passage therethrough and a skirt extending downwardly into the container. The skirt includes an imperforate section dividing the container into a first section open to the passage and a second section separate from the passage. The shirt also includes a lower mesh section juxtaposed to the container walls to keep the marine creatures in the first section where they are accessible through the lid passage. Oxygen is added through the lid into the second section to provide oxygen rich water. The oxygen rich water in the second section mixes with water in the first section to keep the marine creatures alive.

Prior art U.S. Pat. No. 2,656,640, issued Oct. 27, 1953 to Johnson, describes a live bait container that comprises an outer container having a bottom and an open top, an inner perforated wire screen container and an elastic cover therefor.

Prior art U.S. Pat. No. 2,597,002, issued May 20, 1952 to Johnson, illustrates a bait box that has an outer container and an inner perforated container. The inner perforated container has its top closed by an elastic covering, which comprises sheets of elastic material superimposed one above the other. The sheets have offset slots that allow a person's hand through, but will prevent bait from escaping.

Prior art U.S. Pat. No. 2,595,726, issued May 6, 1952 to Swanbeck, discloses a minnow pail that comprises and outer pail with a removable float, and an inner container with wire mesh sidewalls. A hinged door closure is provided at the top of the inner container.

Prior art U.S. Pat. No. 2,272,561, issued Feb. 19, 1942 to Hubbell, indicates a minnow bucket with an inner wire mesh container for holding live bait and an outer imperforate container, which has an ice compartment.

Prior art U.S. Pat. No. 4,428,145, issued Jan. 31, 1984 to Wheeler, discloses a shrimp bait container, which includes a plurality of stacked trays, with each tray storing live shrimp bait in a water medium. Each tray is substantially a frusto-pyramidal shaped housing that has four sides and a bottom, composed of a relatively thick, thermally insulating material. The sides extend upwardly and outwardly from the bottom and are inclined so that the outer surfaces thereof for an upper one of the trays will mate with the inner surfaces thereof for an adjacent, lower one of the trays, forming an enclosed volume for storing the water medium containing the shrimp bait. The bottom of each tray has a perforation therethrough. An adjustable water depth controlling pipe is slideably mounted in substantial vertical orientation in the perforation in the bottom of each housing, having a height above the bottom which can be vertically adjusted and through which water within the enclosed volume may overflow, thus defining the depth of the water. The shrimp bait contained in the water medium can thus be preserved alive in the thermally insulated environment. Overcrowding of the live shrimp can be avoided by selectively adjusting the depth of the water in each tray so as to be shallow enough to prevent the shrimp from smothering one another, consistent with their segregated size and species. The water in each respective stacked tray can be conveniently refreshed by introducing new water in the top tray, which will cascade through each successively lower tray.

Prior art U.S. Pat. No. 3,831,310, issued Aug. 27, 1974 to Frangullie, is for a live bait box that keeps bait from clustering together and thus shortening their lives. The bait bucket is divided into a number of bait storage compartments by means of spacers or partitions. The spacers are preferably perforated with a number of fluid-flow passages, which are large enough to permit the flow of water but restrict the passage of bait from one compartment to another. In addition, the bucket preferable includes a thermal compartment for control over the temperature of the water in which the bait is carried. An optional aeration feature is provided.

Prior art U.S. Pat. No. 458,529, issued Aug. 25, 1891 to Williams, claims a live bait bucket that comprises an outer bucket, a lid and an inner wire-gauze cage, which has a concave bottom for concentration of the bait towards the center for ease of grasping. The device further comprises an ice receptacle on the lid.

Prior art U.S. Pat. No. 302,161, issued Jul. 15, 1884 to Rudolph, shows a minnow bucket with an inner reticulated bucket or net, a buoyant cover therefor and an outer bucket enclosing both.

What is needed is a separating means in a bait container to enable the live bait to spread out over the entire container preventing the bait from smothering each other.

### SUMMARY OF THE INVENTION

An object of the present invention is to provide a mesh liner for a bait container to enable the bait to move along the liner with the live bait spread out along the sides of the container as well as on the bottom, thereby preventing the bait from smothering each other.

Another object of the present invention is to provide a mesh liner that may be easily manufactured in different shapes to fit within a variety of bait containers, such as a bait pail or an ice chest.

One more object of the present invention is to provide an inexpensive mesh liner which prevents the bait from smothering each other, thereby saving the fisherman the added cost of replacing dead bait.

Yet another object of the present invention is to provide a mesh liner for a bait container that saves the fisherman the added time of replacing dead bait, fishermen often purchase their live bait at a location remote from where the bait will be used.

A further object of the present invention is to provide a mesh liner that may be molded into the interior bottom and interior wall surfaces of the bait container when the bait container is formed in the molding process.

In brief, a mesh liner for a bait container that enables the bait to move along the interior of the liner with the live bait spread out along the sides of the container as well as on the bottom thereby preventing the bait from smothering each other. The bottom of the mesh liner is near to or seated against the inner bottom surface of the bait container to allow the live bait to crawl upwards, covering the inner sides of the mesh liner. Under the rim section of the bait container opening the mesh liner may be made to fit in a spaced-apart or a friction fit relationship with the inner portion of the container walls. The mesh liner can be manufactured in different shapes to fit within a variety of bait containers, such as a bait pail or an ice chest. Alternately, the mesh surface may be molded as part of the interior bottom and wall surfaces of the bait container during the molding process.

An advantage of the present invention is that it keeps live bait from smothering each other.

Another advantage of the present invention is that it saves the time and cost of bait replacement.

An additional advantage of the present invention is that it is inexpensive to manufacture.

One more advantage of the present invention is that it can be made to fit a variety of containers.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a live bait container showing the mesh liner device of the present invention inside the bait container and visible through the top opening and side air holes of the bait container;

FIG. 2 is a cross-sectional view of the bait container of FIG. 1 showing the rigid top lip of the mesh lining contacting the interior wall surface of the bait container and the lower portion of the mesh liner positioned away from the container;

FIG. 3 is a cross-sectional view of a portion of the wall surface of the container with the mesh liner spaced apart from the container;

FIG. 4 is a cross-sectional view of a portion of the wall surface of the container with the mesh liner contacting the container;

FIG. 5 is a cross-sectional view of a portion of the wall surface of the container with the mesh liner formed on the interior surface of the container in the molding process of forming the container;

FIG. 6 is a perspective view of an alternate live bait container showing the mesh liner device of the present invention inside the bait container visible through the top opening;

FIG. 7 is a perspective view of an ice cooler chest used as a live bait container showing the mesh liner device of the present invention inside the ice cooler chest and visible through the top opening.

### BEST MODE FOR CARRYING OUT THE INVENTION

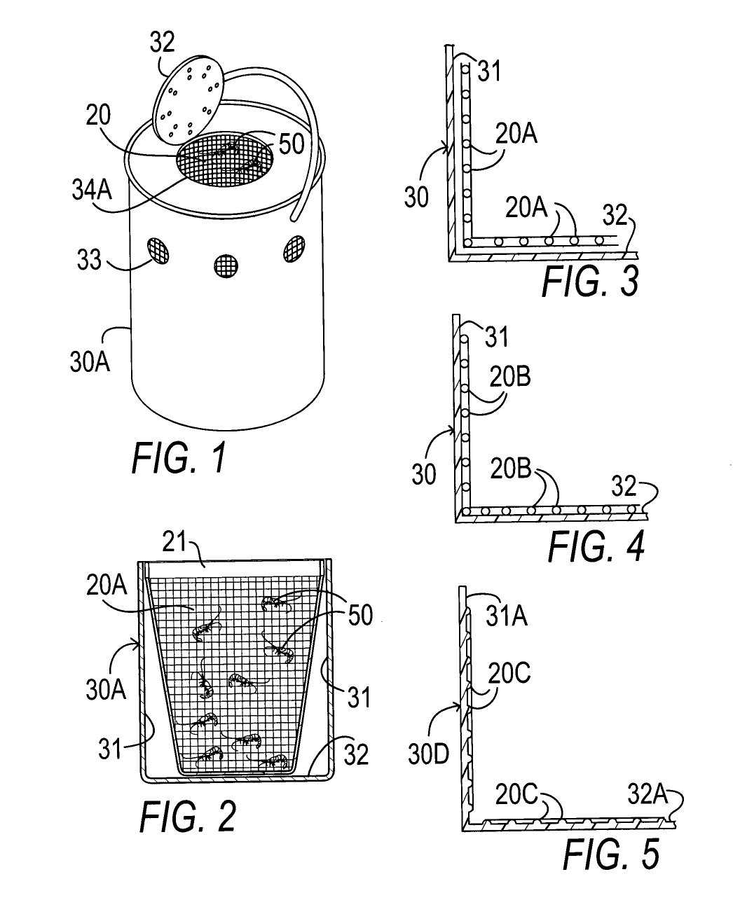

IN FIGS. 1-7, a mesh liner device for a live bait container 30A-C enables the live bait 50 to spread out within the container 30A-C. The device comprises a mesh layer 20 and 20A-C that has a series of linear elements forming a geometrical pattern with spaces between the linear elements in a mesh array. The linear elements are spaced apart a sufficient distance to enable live bait 50 to climb on the mesh layer 20 and 20A-C.

The mesh layer is positioned within a live bait container 30A-C having an interior bottom and surrounding interior wall surfaces, and is positioned in front of and conforming to the shape of the interior wall surfaces and preferably on the interior bottom as well. The mesh layer 20 and 20A-C contacts the interior bottom of the bait container 30A to enable the live bait 50 to crawl from the interior bottom up the mesh layer 20, and 20A-C and spread out within the bait container 30A-C.

As seen in FIG. 2, the mesh layer 20A preferably comprises a preformed structure in the shape of or shaped to cover the interior bottom 32 and interior wall surfaces 31 of the bait container 30A. The mesh layer having a rigid lip 21 formed around the top of the mesh layer, the rigid lip structured to fit with a friction fit against the interior wall surfaces adjacent to the top of the container so that no live bait can climb between the mesh layer and the container. The lower portion of the mesh layer 20A below the rigid lip 21 is spaced apart from the interior wall surfaces 31 of the bait container 30A, as seen in FIG. 2 and the mesh layer 20A may be spaced apart from both the interior wall surfaces 31 and the interior bottom 32, as seen in FIG. 3.

In FIG. 4, the mesh layer 20B may be positioned adjacent to and in contact with either or both the interior wall surfaces 31 and the interior bottom 32 of the container 30.

In FIG. 5, alternately, the mesh layer 20C may be molded into the interior bottom 32A and interior wall surfaces 31 A of the bait container 30D when the bait container 30D is formed in a molding process, such as blow molding.

In practice, the mesh liner may be inserted into a bait container 30A-C so that the rigid top lip 21 of the mesh liner 20A contacts the interior wall surface 31 of the bait container 30A, is in FIG. 2 and the lower portion of the mesh liner 20A is positioned away from the interior wall surface 31, as shown in FIGS. 2 and 3 or in contact with the interior wall surface 31 and bottom interior 32, is in FIG. 4.

Alternately, the mesh liner 20C may be formed on the interior surface of the container 30D in the molding process of forming the container 30D, as shown in FIG. 5 and therefore, be pre-installed and ready for use.

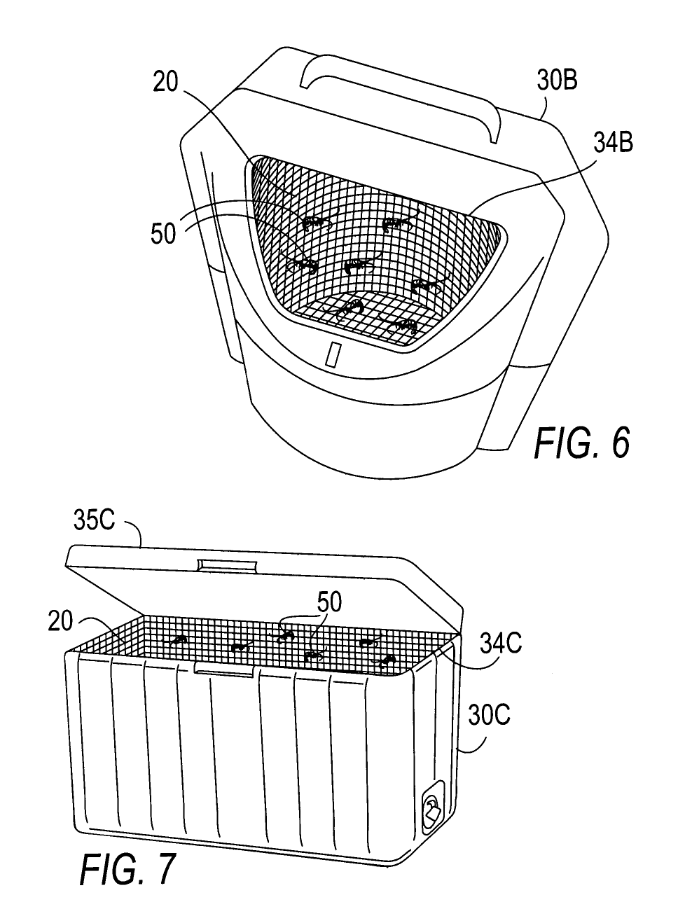

Mesh liners 20 may be installed in various types of bait containers such as a bucket type live bait container 30A with a top opening 34A and side air holes 33 an in FIGS. 1 and 2 or a molded type of live bait container 30B with an angled opening 34B as in FIG. 6.

In a further embodiment of FIG. 7, an ice cooler chest 30C with a hinged lid 35C may be used as a live bait container 30C with the mesh liner device 20 installed inside the ice cooler chest 30C and visible through the top opening 31C.

After purchasing live bait 50, such as shrimp or crayfish, a fisherman may place the live bait 50 inside of the mesh lining device 20 and close the lid 32 or 32C. The live bait 50 will then spread out over the entire surface of the mesh lining 20A-20C, as shown in FIGS. 1, 2, 6 and 7, thereby preventing the bait 50 from smothering each other.

The mesh liner 20 and 20A-B may be a plastic molded mesh or a wire mesh or any other type of mesh enabling live bait, such as shrimp, crayfish, crawfish or the like, to climb on the mesh.

It is understood that the preceding description is given merely by way of illustration and not in limitation of the invention and that various modifications may be made thereto without departing from the spirit of the invention as claimed.

1. A liner device for a live bait container to enable the live bait to spread out within the container, the device comprising:
a mesh layer having a series of linear elements forming a geometrical pattern with spaces between the linear elements, the linear elements spaced apart a sufficient distance to enable live bait to climb on the mesh layer, the mesh layer positioned within a live bait container having an interior bottom and surrounding interior wall surfaces, the mesh layer positioned in front of and conforming to the shape of the interior wall surfaces and the mesh layer contacting the interior bottom to enable the live bait to crawl from the interior bottom up the mesh layer and spread out within the bait container.

2. The device of claim 1 wherein the mesh layer comprises a preformed structure in the shape of the interior bottom and interior wall surfaces of the bait container, the mesh layer having a rigid lip formed around the top of the mesh layer, the rigid lip structured to fit with a friction fit against the interior wall surfaces adjacent to the top of the container so that no live bait can climb between the mesh layer and the container.

3. The device of claim 2 wherein a lower portion of the mesh layer below the rigid lip contacts the interior bottom and interior wall surfaces of the bait container.

4. The device of claim 2 wherein a lower portion of the mesh layer below the rigid lip is spaced apart from the interior bottom and interior wall surfaces of the bait container.

5. The device of claim 2 wherein the mesh layer is molded into the interior bottom and interior wall surfaces of the bait container when the bait container is formed by a molding process.
